(19) United States
(12) Patent Application Publication
(10) Pub. No.: US 2010/0036577 A1
(43) Pub. Date: Feb. 11, 2010

(54) BRAKING APPARATUS AND METHOD FOR CONTROLLING BRAKING APPARATUS

(76) Inventors: Shinya Kodama, Shizuoka-ken (JP); Michihito Shimada, Shizuoka-ken (JP); Kazuya Maki, Aichi-ken (JP)

Correspondence Address: KENYON & KENYON LLP, 1500 K STREET N.W., SUITE 700, WASHINGTON, DC, 20005, US

(21) Appl. No.: 12/523,488

(22) PCT Filed: Mar. 11, 2008
(86) PCT No.: PCT/JP2008/054409

§ 371 Date: Jul. 16, 2009

(30) Foreign Application Priority Data
Mar. 29, 2007 (JP) 2007-089885

(51) Int. Cl. G06F 17/00; B60T 8/00

(52) U.S. Cl. 701/76; 303/152

(57) ABSTRACT

A braking apparatus includes a hydraulic brake device that generates pressure braking-force by wheel cylinder pressure, the hydraulic brake device including a master cylinder for exerting a master cylinder pressure on a brake oil according to a manipulation force generated by the manipulation of a brake pedal by a driver, a brake booster for assisting the manipulation force by a negative pressure generated by an internal combustion engine, and a negative pressure sensor for detecting the negative pressure of the brake booster, and a regenerative braking device for generating a regenerative braking-force by performing regenerative braking. The regenerative braking device generates a regenerative braking when the detected negative pressure is lower than a reference negative pressure to be greater than when the detected negative pressure is the reference negative pressure. The uncomfortable feeling felt by the driver in manipulating the brake is suppressed, and the fuel consumption is enhanced.

This is a 371 national phase application of PCT/JP2008/054409 filed 11 Mar. 2008, claiming priority to Japanese Patent Application No. JP 2007-089885 filed 29 Mar. 2007, the contents of which are incorporated herein by reference.

### FIELD OF THE INVENTION

The present invention relates to a braking apparatus and a method for controlling the braking apparatus, and more specifically to a braking apparatus including an assisting means for assisting manipulation force by the negative pressure generated by an internal combustion engine, and a method for controlling the braking apparatus.

### BACKGROUND OF THE INVENTION

A braking apparatus is conventionally used as an apparatus for causing a vehicle to generate a braking force. The braking apparatus generates the braking force when the driver manipulates the brake pedal. For instance, the braking apparatus mounted on a hybrid vehicle in which the front wheels are driven with the internal combustion engine, and the rear wheels are driven by a motor generator includes a pressure braking means for generating a pressure braking-force by the pressure of the operation fluid, and a regenerative braking means for generating a regenerative braking-force by performing regenerative braking. Specifically, a hydraulic brake device for generating the pressure braking-force by a wheel cylinder pressure that acts on the wheel cylinder, and a regenerative braking device for generating the regenerative braking-force by causing the motor generator to perform the regenerative brake control are arranged. In the braking apparatus mounted on the hybrid vehicle, the braking force corresponding to the braking request of the driver is generated by the total braking-force of the pressure braking-force generated by the pressure braking system and the regenerative braking-force generated by the regenerative braking device.

In the hydraulic brake device, a master cylinder exerts manipulation pressure on the brake oil according to the manipulation force generated by the manipulation of the brake pedal by the driver, and the exerted manipulation pressure acts on the wheel cylinder as a wheel cylinder pressure. Some hydraulic brake devices include a brake booster for assisting the manipulation force generated by the manipulation of the brake pedal by the driver with the negative pressure generated by the internal combustion engine. In the brake booster, the assisting force for assisting the manipulation force lowers with lowering of the negative pressure generated by the internal combustion engine, that is, lowering of the negative pressure supplied to the brake booster.

Since the hybrid vehicle can travel by the motor generator even if the operation of the internal combustion engine is stopped, the braking apparatus sometimes generate the braking force based on the braking request of the driver. In this case, sufficient negative pressure is not generated since the operation of the internal combustion engine is stopped, and the negative pressure to be supplied to the brake booster is lowered. Therefore, when the operation of the internal combustion engine is stopped, the assisting force with which the brake booster assists the manipulation force is small compared to that when the engine is running. Thus, the manipulation pressure exerted on the brake oil by the master cylinder lowers when the internal combustion engine is not running compared to that when the internal combustion engine is running, whereby a difference is generated between the total braking-force generated by the braking apparatus and the braking force based on the braking request of the driver, and the braking force becomes insufficient. In order to compensate for the lack of braking force, the driver needs to further press on the brake pedal to increase the manipulation force generated by the manipulation of the brake pedal, and an uncomfortable feeling arises in the manipulation of the brake.

In the conventional braking apparatus, a technique of restarting the internal combustion engine according to the negative pressure generated by the internal combustion engine is proposed as described, for example, in Patent Document 1. In the conventional technology disclosed in Patent Document 1, the negative pressure generated by the internal combustion engine is estimated when the operation of the internal combustion engine (engine) is stopped, and the internal combustion engine is restarted according to the estimated negative pressure. In the technology disclosed in Patent Document 1, a case where the negative pressure generated by the internal combustion engine lowers and the assisting force by the brake booster is not sufficiently obtained with respect to the manipulation force is suppressed, and the uncomfortable feeling of the driver in manipulating the brake is suppressed.

Patent Document 1: Japanese Patent Application Laid-open No. 2004-132248

### SUMMARY OF INVENTION

### Problems to be Solved by the Invention

However, in the conventional technology described in Patent Document 1, the lack of braking force is compensated when the operation of the internal combustion engine is stopped for the purpose of improving fuel consumption, and the internal combustion engine is restarted to suppress the uncomfortable feeling of the driver in manipulating the brake, and thus the fuel compensation may not improve.

In view of the above problems, it is an object of the present invention to provide a braking apparatus capable of suppressing the uncomfortable feeling of the driver in manipulating the brake and improving fuel consumption, and a method for controlling the braking apparatus.

### Means for Solving Problem

In order to solve the above problems, and to achieve the object, a braking apparatus according to the present invention includes a brake pedal manipulated by a driver; a pressure braking-force generating unit that generates a pressure braking-force by applying a manipulation pressure corresponding to a manipulation force of the brake pedal and an assisting pressure corresponding to an assisting force that assists the manipulation force on a wheel; a regenerative braking unit that generates a regenerative braking-force at an axle to which the wheel is attached based on a rotational force of the wheel; an assisting force detection unit that detects the assisting force; and a request braking-force calculating unit that calculates a request braking-force according to a pedal force of the driver on the brake pedal, wherein the request braking-force calculating unit calculates the request braking-force to be greater than that when the assisting force is a reference value, when the detected assisting force is smaller than the reference value; and the regenerative braking unit generates a difference between the calculated request braking-force and the pressure braking-force.

According to the present invention, in the braking apparatus, the assisting force may be based on a negative pressure generated by an internal combustion engine, and the assisting force detection means may be a negative pressure sensor that detects the negative pressure.

According to the present invention, in the braking apparatus, a case that the detected negative pressure is lower than the reference value may be a case that a braking request is made by the driver while the operation of the internal combustion engine is stopped.

According to the present invention, a method for controlling a braking apparatus based on a braking request of a driver includes the steps of detecting an assisting force that assists a manipulation force of a brake pedal; judging whether the detected assisting force is smaller than a reference value; calculating a request braking-force when the detected negative pressure is lower than a reference value to be greater than a request braking-force when the detected negative pressure is the reference value; and generating, by a regenerative braking unit, a difference between the calculated request braking-force and a pressure braking-force generated by applying a manipulation pressure corresponding to the manipulation force and an assisting pressure corresponding to the assisting force on a wheel as a regenerative braking-force at an axle to which the wheel is attached based on a rotational force of the wheel.

According to the present invention, the request braking-force calculating means calculates the request braking-force when the detected assisting force is smaller than a reference value, that is, when the detected negative pressure is lower than the reference value (e.g., when operation of the internal combustion engine is stopped) to be greater than the request braking-force when the detected negative pressure is the reference value. That is, the request braking-force calculated when the detected assisting force is smaller than the reference value becomes greater than the request braking-force calculated when the detected assisting force is the reference value. The regenerative braking means generates the difference between the calculated request braking-force and the pressure braking-force as the regenerative braking-force, and thus the regenerative braking-force generated when the detected assisting force is smaller than the reference value becomes greater than the regenerative braking-force generated when the detected assisting force is the reference value. Therefore, the lack of braking force that occurs when the assisting force that assists the manipulation force is lowered, that is, when the negative pressure generated by the internal combustion engine is lowered is compensated by the regenerative braking-force with the negative pressure generated by the internal combustion engine lowered such as with the operation of the internal combustion engine stopped. Thus, the uncomfortable feeling felt by the driver in manipulating the brake is suppressed, and the fuel consumption can be enhanced.

According to the present invention, in the braking apparatus, a manipulation speed detection unit that detects a manipulation speed of the brake pedal may be further included, wherein the regenerative braking unit may change the regenerative braking-force to be generated according to the detected manipulation speed.

According to the present invention, in the braking apparatus, the regenerative braking unit may increase the regenerative braking-force to be generated with increase in the detected manipulation speed to a depressing side of the brake pedal, when the detected manipulation speed is on a depressing side.

According to the present invention, in the braking apparatus, the regenerative braking unit may decrease the regenerative braking-force to be generated with decrease in the detected manipulation speed to a returning side of the brake pedal, when the detected manipulation speed is on a returning side.

According to the present invention, the response characteristics of the assisting means that generates the assisting pressure corresponding to the assisting force that assists the manipulation force changes according to the manipulation speed of the brake pedal by the driver, and thus even if the assisting force to be supplied to the assisting means, that is, the negative pressure generated by the internal combustion engine changes, and the assisting pressure changes, the regenerative braking means can generate the regenerative braking-force following the change in the assisting pressure. Therefore, the lack of braking force or excess of braking force due to change in the response characteristics of the assisting means can be compensated by the regenerative braking-force. Thus, the uncomfortable feeling felt by the driver in manipulating the brake is suppressed, and the fuel consumption can be enhanced.

According to the present invention, in the braking apparatus, a pressurizing unit that applies pressurizing pressure on the wheel regardless of the manipulation of the brake pedal by the driver may be further included, wherein if the detected assisting force is smaller than a reference value, the regenerative braking unit and the pressurizing unit are operated, the regenerative braking unit being operated in preference to the pressurizing unit so that the difference between the referenced total braking-force and the total detected braking force becomes smaller by the regenerative braking-force rather than by the pressure braking-force.

According to the present invention, when lack of braking force occurs, the lack of braking force is compensated by operating the regenerative braking means that can generate energy in preference to the pressurizing means that consumes energy generated by a vehicle in which the braking apparatus is mounted. Therefore, the fuel consumption can be further enhanced.

### EFFECT OF THE INVENTION

The braking apparatus and the method for controlling the braking apparatus according to the present invention provide effects of suppressing the uncomfortable feeling felt by the driver in manipulating the brake, and enhancing the fuel consumption by compensating the lack of braking force with the regenerative braking-force.

### BRIEF DESCRIPTION OF DRAWINGS

FIG. 1 is a view showing a schematic configuration example of a braking apparatus according to an embodiment.

FIG. 2 is a view showing a schematic configuration example of a hydraulic brake device.

FIG. 3 is a diagram showing a PMC-Fpd-PV map.

FIG. 4 is a diagram showing a PMC-Fpd-dST(+) map.

FIG. 5 is a diagram showing a PMC-Fpd-dST(−) map.

FIG. 6 is a diagram showing a BF*-Fpd map.

FIG. 7 is a diagram showing a Pp-I map.

FIG. 8 is a view showing a flow of a method for controlling the braking apparatus according to the embodiment.

### EXPLANATIONS OF LETTERS OR NUMERALS

1 braking apparatus
2 hydraulic brake device (pressure braking-force generating unit)
21 brake pedal
21a stroke sensor
22 master cylinder
22a reservoir
23 brake booster
23a negative pressure sensor (assisting force detection unit)
23b negative pressure piping
23c check valve
24 master cylinder pressure sensor
25 brake actuator
25a, 25b master cut solenoid valve (pressurizing unit)
25c to 25f holding solenoid valve
25g to 25j depressurizing solenoid valve
25k, 25l reservoir
25m, 25n pressurizing pump (pressurizing unit)
26a to 26d wheel cylinder
27a to 27d brake pad
28a to 28d brake rotor
29 brake control device
29a input/output unit
29b processing unit
29c storage unit
29d request braking-force calculating unit
29e target regenerative braking-force calculating unit
29f pressurizing braking-force calculating unit
29g valve opening control unit
29h pump drive control unit.
3 regenerative braking device (regenerative braking unit)
31 motor generator
32 inverter
33 battery
34 motor generator control device
4 hybrid control device
BF* request braking-force
BFpmc manipulation braking-force
BFpp pressurizing braking-force
BFr* target regenerative braking-force
BTK execution regenerative braking-force
Fpd pedal force
I command current value
Pp pressurizing pressure
PMC master cylinder pressure
PV negative pressure
ST stroke amount
dST manipulation speed

### DETAILED DESCRIPTION

The present invention will be described in detail below with reference to the drawings. It should be noted that the present invention is not limited by the following embodiment. The configuring elements in the following embodiment include those easily assumed by those skilled in the art or substantially the same configuring elements. Furthermore, a case where the braking apparatus according to the present invention is mounted on a hybrid vehicle in which the front wheels are driven by an internal combustion engine and the rear wheels are driven by a motor generator will be described in the following embodiment, but the present invention is not limited thereto. The vehicle in which the braking apparatus is mounted according to the present invention may be a hybrid vehicle in which the wheels are driven by at least one of the internal combustion engine or the motor generator through a power transmission mechanism.

### Embodiment

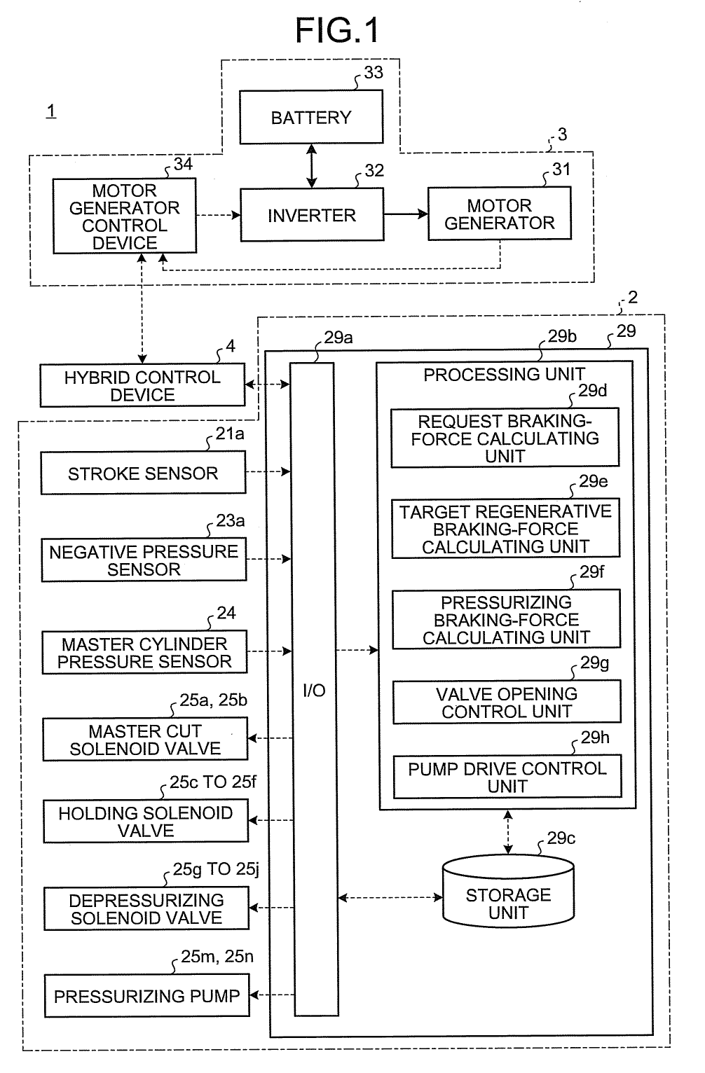

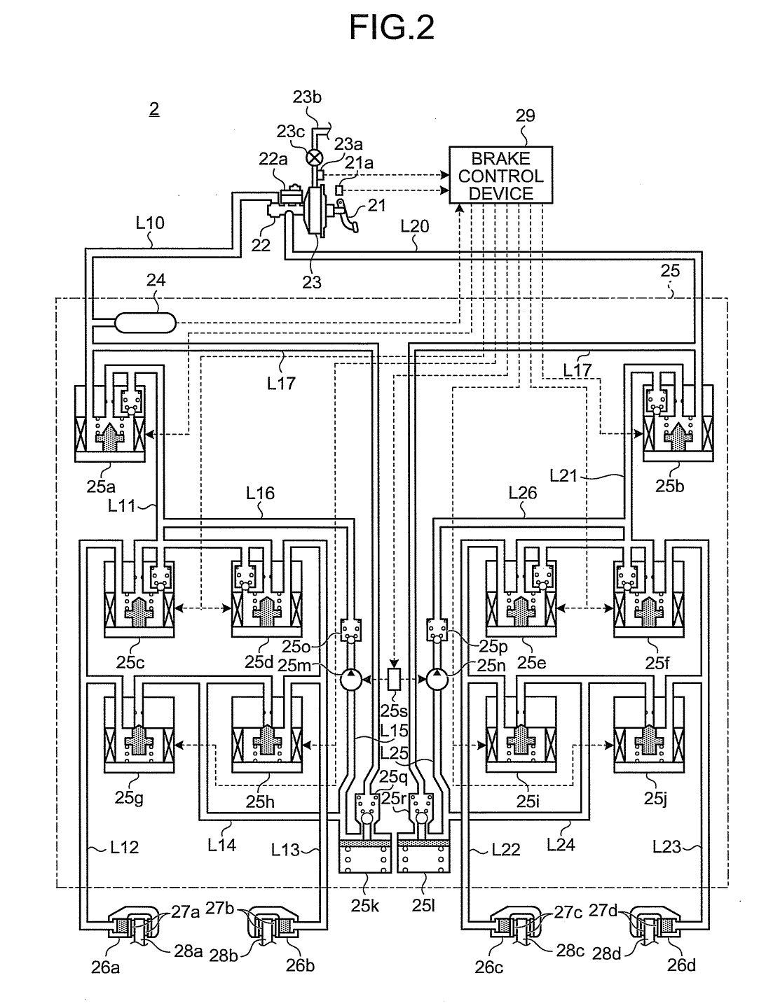

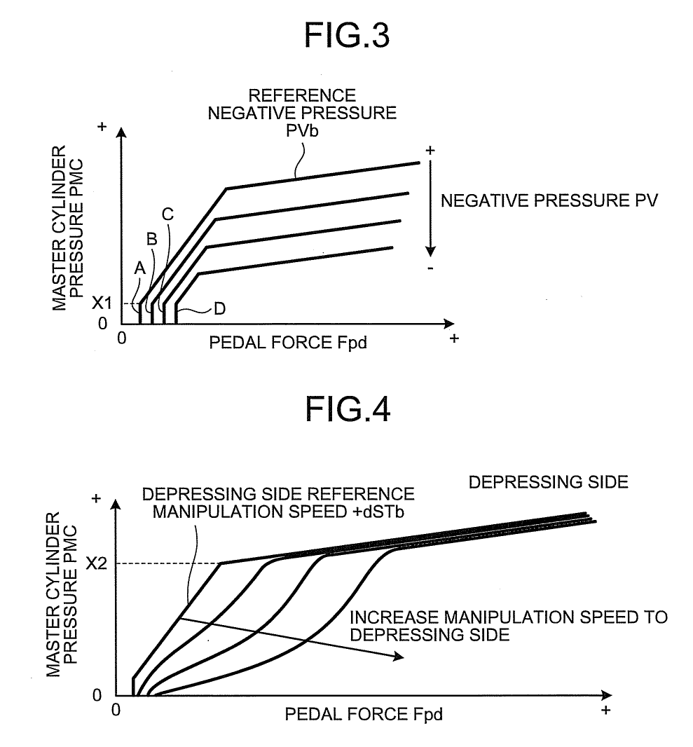

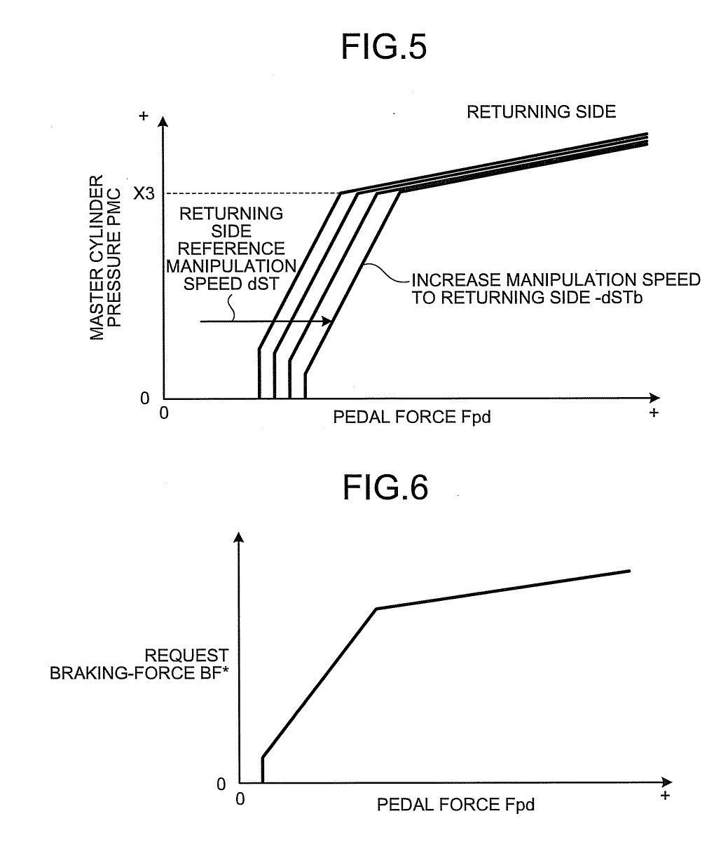

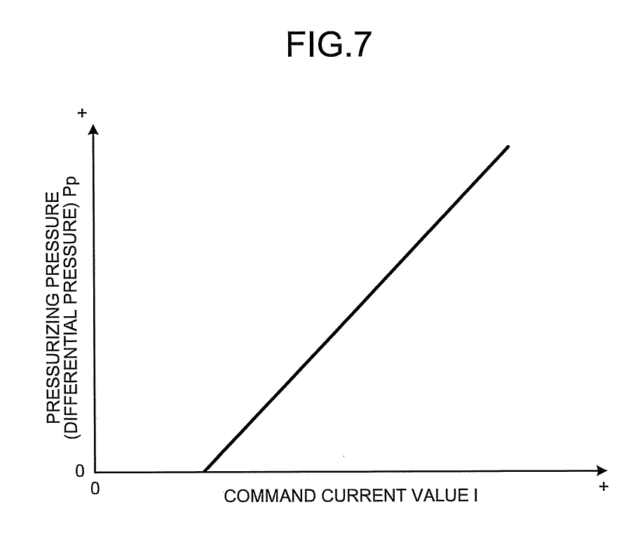

FIG. 1 is a view showing a schematic configuration example of a braking apparatus according to the embodiment. FIG. 2 is a view showing a schematic configuration example of a hydraulic brake device. FIG. 3 is a diagram showing a PMC-Fpd-PV map. FIG. 4 is a diagram showing a PMC-Fpd-dST(+) map. FIG. 5 is a diagram showing a PMC-Fpd-dST(−) map. FIG. 6 is a diagram showing a BF*-Fpd map. FIG. 7 is a diagram showing a Pp-I map. As shown in FIG. 1 and FIG. 2, a braking apparatus 1 according to the embodiment is mounted on a hybrid vehicle (not shown), and is configured by a hydraulic brake device 2, a regenerative braking device 3, and a hybrid control device 4. The braking apparatus 1 generates a braking force based on the braking request of the driver from the total braking-force of the pressure braking-force generated by the hydraulic brake device 2 and the regenerative braking-force generated by the regenerative braking device 3.

The hydraulic brake device 2 is a pressure braking means that generates pressure braking-force. As shown in FIG. 2, the hydraulic brake device 2 is configured by a brake pedal 21, a stroke sensor 21a, a master cylinder 22, a reservoir 22a, a brake booster 23, a negative pressure sensor 23a, a master cylinder pressure sensor 24, a brake actuator 25, wheel cylinders 26a, 26b, 26c, 26d, brake pads 27a, 27b, 27c, 27d, brake rotors 28a, 28b, 28c, 28d, and a brake control device 29. In the hydraulic brake device 2, the brake oil, which is the operation fluid, is filled into a hydraulic path to each wheel cylinder 26a to 26d through the brake actuator 25 from the master cylinder 22. In the hydraulic brake device 2, basically, when the driver manipulates the brake pedal 21, the master cylinder pressure is exerted as the total pressure of the manipulation pressure on the brake oil by the master cylinder 22 according to the manipulative force generated through the brake pedal 21 and the assisting pressure on the brake oil by the master cylinder 22 according to the negative pressure or the assisting force generated by the brake booster 23. The master cylinder pressure exerted on the brake oil acts as the pressure of the brake oil, that is, the wheel cylinder pressure on each wheel cylinder 26a to 26d so that the manipulation pressure and the assisting pressure are applied on the wheels and the pressure braking-force is generated.

The brake pedal 21 is manipulated when the driver generates the braking force with respect to the hybrid vehicle (not shown), that is, according to the braking request. The stroke sensor 21a detects the depressed amount, that is, the stroke amount of the brake pedal 21 when the driver depresses the brake pedal 21, and is also a manipulation speed detection means for detecting the manipulation speed of the brake pedal 21 based on the detected stroke amount. The stroke sensor 21a is connected to the brake control device 29, so that the stroke amount of the brake pedal 21 detected by the stroke sensor 21a is output to the brake control device 29.

The master cylinder 22 is a manipulation pressure exerting means that pressurizes the brake oil, which is the operation fluid, according to the manipulation force generated by the manipulation of the brake pedal 21 by the driver and the assisting force generated by the brake booster 23, and exerts the master cylinder pressure, which is the total pressure of the manipulation pressure and the assisting pressure. The master cylinder 22 pressurizes the brake oil with a piston (not shown) on which the manipulation force generated through the brake pedal 21 when the driver depresses the brake pedal 21 is exerted. The master cylinder 22 is coupled with the reservoir 22a, which reservoir 22a stores the brake oil of the hydraulic path.

The brake booster 23 is an assisting means that assists the manipulation force with the assisting force. In the embodiment, the brake booster 23 generates the assisting force based on the negative pressure generated by the internal combustion engine (not shown), and assists the manipulation force generated by the manipulation of the brake pedal 21 by the driver. The brake booster 23 is, for example, a vacuum-type force multiplying device connected to an air intake path of the internal combustion engine (not shown) by way of a negative pressure piping 23b and a check valve 23c, and is supplied with the negative pressure generated by the internal combustion engine. The brake booster 23 assists the manipulation force with the force, which acts on a diaphragm (not shown) by the differential pressure of the supplied negative pressure and the pressure by outside air, as the assisting force. That is, in the brake booster 23, the assisting force that assists the manipulation force changes according to the negative pressure generated by the internal combustion engine. For instance, the assisting force that assists the manipulation force becomes large if the supplied negative pressure is large. Therefore, the brake oil is pressurized by the master cylinder 22, and the master cylinder pressure is exerted on the brake oil according to the manipulation force assisted by the brake booster 23. That is, the master cylinder pressure corresponds to the manipulation force on the brake pedal 21 of the driver and the negative pressure generated by the internal combustion engine. The negative pressure sensor 23a is an assisting force detection means that detects the assisting force generated by the brake booster 23, which is the assisting means, by detecting the negative pressure generated by the internal combustion engine or the negative pressure of the brake booster 23. The negative pressure sensor 23a is arranged in the middle of the negative pressure piping 23b. That is, the negative pressure sensor 23a detects the pressure in the negative pressure piping 23b as the negative pressure of the brake booster 23. The negative pressure sensor 23a is connected to the brake control device 29, so that the negative pressure detected by the negative pressure sensor 23a is output to the brake control device 29.

The master cylinder pressure sensor 24 is a manipulation pressure detection means that detects the master cylinder pressure, which is the total pressure of the manipulation pressure and the assisting pressure. In the embodiment, the master cylinder pressure sensor 24 is arranged in the middle of a hydraulic piping L10 for connecting the master cylinder 22 and a first master cut solenoid valve 25a, to be hereinafter described, of the brake actuator 25. That is, the master cylinder pressure sensor 24 detects the pressure of the brake oil in the hydraulic piping L10 as the manipulation pressure, that is, the master cylinder pressure. The master cylinder pressure sensor 24 is connected to the brake control device 29, so that the master cylinder pressure detected by the master cylinder pressure sensor 24 is output to the brake control device 29.

The brake actuator 25 controls the wheel cylinder pressure exerted on each wheel cylinder 26a to 26d according to the master cylinder pressure applied on the brake oil by the master cylinder 22, or allows the wheel cylinder pressure to act on each wheel cylinder 26a to 26d regardless of whether or not the master cylinder pressure is exerted on the brake oil by the master cylinder 22. The brake actuator 25 is configured by master cut solenoid valves 25a, 25b, holding solenoid valves 25c, 25d, 25e, 25f, depressurizing solenoid valves 25g, 25h, 25i, 25j, reservoirs 25k, 25l, pressurizing pumps 25m, 25n, check valves 250, 25p, 25q, 25r, and hydraulic piping L10 to L17, L20 to L27.

Each master cut solenoid valve 25a, 25b configures part of the pressurizing means, and pressure-adjusts the pressurizing pressure. The master cut solenoid valve 25a is connected to the hydraulic piping L10 and the hydraulic piping L11, communicates or cuts off the communication of the hydraulic piping L10 and the hydraulic piping L11, and pressure-adjusts the differential pressure between the upstream side and the downstream side of the master cut solenoid valve 25a in time of communication. That is, the master cut solenoid valve 25a adjusts the pressure of the brake oil pressurized by the pressurizing pump 25m, that is, the differential pressure of the wheel cylinder pressure and the master cylinder pressure as the pressurizing pressure. The master cut solenoid valve 25b is connected to the hydraulic piping L20 and the hydraulic piping L21, communicates or cuts off the communication of the hydraulic piping L20 and the hydraulic piping L21, and pressure-adjusts the differential pressure between the upstream side and the downstream side of the master cut solenoid valve 25b in time of communication. That is, the master cut solenoid valve 25b adjusts the pressure of the brake oil pressurized by the pressurizing pump 25n, that is, the differential pressure of the wheel cylinder pressure and the master cylinder pressure as the pressurizing pressure. The master cut solenoid valves 25a, 25b are linear solenoid valves, and are connected to the brake control device 29. Therefore, in each master cut solenoid valve 25a, 25b, the current to be supplied is controlled based on the command current value from the brake control device 29, and the opening control of controlling the opening is performed. That is, the master cut solenoid valves 25a, 25b pressure-adjust the pressurizing pressure according to the current value. Each master cut solenoid valve 25a, 25b is not supplied with current, that is, fully opened in non-conduction.

The holding solenoid valve 25c is connected to the hydraulic piping L11 connecting to the master cylinder 22 and the hydraulic piping L12 connecting to the wheel cylinder 26a, and communicates or cuts off the communication of the hydraulic piping L11 and the hydraulic piping L12. That is, the holding solenoid valve 25c connects or cuts off the connection of the master cylinder 22 and the wheel cylinder 26a. The holding solenoid valve 25d is connected to the hydraulic piping L11 connecting to the master cylinder 22 and the hydraulic piping L13 connecting to the wheel cylinder 26b, and communicates or cuts off the communication of the hydraulic piping L11 and the hydraulic piping L13. That is, the holding solenoid valve 25d connects or cuts off the connection of the master cylinder 22 and the wheel cylinder 26b. The holding solenoid valve 25e is connected to the hydraulic piping L21 connecting to the master cylinder 22 and the hydraulic piping L22 connecting to the wheel cylinder 26c, and communicates or cuts off the communication of the hydraulic piping L21 and the hydraulic piping L22. That is, the holding solenoid valve 25e connects or cuts off the connection of the master cylinder 22 and the wheel cylinder 26c. The holding solenoid valve 25f is connected to the hydraulic piping L21 connecting to the master cylinder 22 and the hydraulic piping L23 connecting to the wheel cylinder 26d, and communicates or cuts off the communication of the hydraulic piping L21 and the hydraulic piping L23. That is, the holding solenoid valve 25f connects or cuts off the connection of the master cylinder 22 and the wheel cylinder 26d. Each holding solenoid valve 25c to 25f is a constantly-opened solenoid valve, and is connected to the brake control device 29. Therefore, each holding solenoid valve 25c to 25f is open/close controlled by the ON/OFF control of the brake control device 29. Each holding solenoid valve 25c to 25f is in the conduction state when turned ON by the brake control device 29, and is fully closed in time of conduction. Each holding solenoid valve is in the non-conduction state when turned OFF by the brake control device 29, and is fully opened in time of non-conduction. Each holding solenoid valve 25c to 25f is provided with a check valve for returning the brake oil to the upstream side (hydraulic piping L11, L21 side) of each holding solenoid valve 25c to 25f when the wheel cylinder pressure acting on each wheel cylinder 26a to 26d is higher than the master cylinder pressure in time of conduction.

The depressurizing solenoid valve 25g is connected to the hydraulic piping L12 connecting to the wheel cylinder 26a and the hydraulic piping L14 connecting to the reservoir 25k, and communicates and cuts off the communication of the hydraulic piping L12 and the hydraulic piping L14. That is, the depressurizing solenoid valve 25g connects and cuts off the connection of the wheel cylinder 26a and the reservoir 25k. The depressurizing solenoid valve 25h is connected to the hydraulic piping L13 connecting to the wheel cylinder 26b and the hydraulic piping L14 connecting to the reservoir 25k, and communicates and cuts off the communication of the hydraulic piping L13 and the hydraulic piping L14. That is, the depressurizing solenoid valve 25h connects and cuts off the connection of the wheel cylinder 26b and the reservoir 25k. The depressurizing solenoid valve 25i is connected to the hydraulic piping L22 connecting to the wheel cylinder 26c and the hydraulic piping L24 connecting to the reservoir 25l, and communicates and cuts off the communication of the hydraulic piping L22 and the hydraulic piping L24. That is, the depressurizing solenoid valve 25i connects and cuts off the connection of the wheel cylinder 26c and the reservoir 25l. The depressurizing solenoid valve 25j is connected to the hydraulic piping L23 connecting to the wheel cylinder 26d and the hydraulic piping L24 connecting to the reservoir 25l, and communicates and cuts off the communication of the hydraulic piping L23 and the hydraulic piping L24. That is, the depressurizing solenoid valve 25j connects and cuts off the connection of the wheel cylinder 26d and the reservoir 25l. Each depressurizing solenoid valve 25g to 25j is a constantly-closed solenoid valve, and is connected to the brake control device 29. Therefore, each depressurizing solenoid valve 25g to 25j is open/close controlled by the ON/OFF control of the brake control device 29. Each depressurizing solenoid valve 25g to 25j is in the conduction state when turned ON by the brake control device 29, and is fully opened in time of conduction. Each depressurizing solenoid valve is in the non-conduction state when turned OFF by the brake control device 29, and is fully closed in time of non-conduction.

The reservoir 25k is connected to the hydraulic piping L15 connecting to the hydraulic piping L14 and the pressurizing pump 25m and the hydraulic piping L17 communicating to the hydraulic piping L10 by way of the check valve 25q. Therefore, to the reservoir 25k can be introduced the brake oil from the depressurizing solenoid valves 25g, 25h, or the brake oil on the upstream side of the hydraulic piping L10, that is, the master cut solenoid valve 25a. The reservoir 25l is connected to the hydraulic piping L25 connecting to the hydraulic piping L24 and the pressurizing pump 25n and the hydraulic piping L27 communicating to the hydraulic piping L20 by way of the check valve 25r. Therefore, to the reservoir 25l can be introduced the brake oil from the depressurizing solenoid valves 25i, 25j, or the brake oil on the upstream side of the hydraulic piping L20, that is, the master cut solenoid valve 25b.

Each pressurizing pump 25m, 25n configures part of the pressurizing means, and pressurizes the brake oil. The pressurizing pump 25m is connected to the hydraulic piping L15 connecting to the reservoir 25k, and the hydraulic piping L16 communicating to the hydraulic piping L11 by way of the check valve 25o. Therefore, the pressurizing pump 25m takes in the brake oil on the upstream side of the master cut solenoid valve 25a through the reservoir 25k, pressurizes and discharges the same to the downstream side of the hydraulic piping L11, that is, the master cut solenoid valve 25a. The pressurizing pump 25n is connected to the hydraulic piping L25 connecting to the reservoir 25l, and the hydraulic piping L26 communicating to the hydraulic piping L21 by way of the check valve 25p. Therefore, the pressurizing pump 25n takes in the brake oil on the upstream side of the master cut solenoid valve 25b through the reservoir 25l, pressurizes and discharges the same to the downstream side of the hydraulic piping L21, that is, the master cut solenoid valve 25b. Each pressurizing pump 25m, 25n is driven by the drive motor 25s. The drive motor 25s is connected to the brake control device 29. Therefore, each pressurizing pump 25m, 25n is driven when the drive motor 25s is drive-controlled by the brake control device 29. As described above, the pressurizing means pressurizes the brake oil by each pressurizing pump 25m, 25n, and exerts the pressurizing pressure on the brake oil by pressure-adjusting the pressure of the pressurized brake oil, that is, the differential pressure of the wheel cylinder pressure acting on each wheel cylinder 26a to 26d and the master cylinder pressure by each master cut solenoid valve 25a, 25b.

The operation of the brake actuator 25 will be described below. When the brake actuator 25 is in the pressure-increasing mode, the brake control device 29 controls the brake actuator 25 such that each master cut solenoid valve 25a, 25b is non-conductive, each holding solenoid valve 25c to 25f is non-conductive, each depressurizing solenoid valve 25g to 25j is non-conductive, and each pressurizing pump 25m, 25n is non-driven. In the pressure-increasing mode, the master cylinder 22 and each wheel cylinder 26a to 26d is connected by way of the hydraulic piping L10, L20, each master cut solenoid valve 25a, 25b, the hydraulic piping L11, L21, each holding solenoid valve 25c to 25f, and the hydraulic piping L12, L22. Therefore, the master cylinder pressure exerted on the brake oil by the master cylinder 22 directly acts on each wheel cylinder 26a to 26d as the wheel cylinder pressure. The wheel cylinder pressure that acts on each wheel cylinder 26a to 26d can be controlled according to the master cylinder pressure. When the master cylinder pressure exerted on the brake oil by the master cylinder 22 decreases, the wheel cylinder pressure also decreases, but the brake oil in each wheel cylinder 26a to 26d is returned to the master cylinder 22 through the hydraulic piping L12, L22, each holding solenoid valve 25c to 25f, the hydraulic piping L11, L21, each master cut solenoid valve 25a, 25b, and the hydraulic piping L10, L20, and stored in the reservoir 22a.

When the brake actuator 25 is in the holding mode, the brake control device 29 controls the brake actuator 25 such that the master cut solenoid valves 25a, 25b are non-conductive, each holding solenoid valve 25c to 25f is conductive, each depressurizing solenoid valve 25g to 25j is non-conductive, and each pressurizing pump 25m, 25n is non-driven. In the holding mode, the brake oil is held between each holding solenoid valve 25c to 25f and each wheel cylinder 26a to 26d, and thus the wheel cylinder pressure acting on each wheel cylinder 26a to 26d can be maintained constant. When the brake actuator 25 is in the pressure-reducing mode, the brake control device 29 controls the brake actuator 25 such that the master cut solenoid valves 25a, 25b are non-conductive, each holding solenoid valve 25c to 25f is conductive, each depressurizing solenoid valve 25g to 25j is conductive, and each pressurizing pump 25m, 25n is non-driven. In the pressure-reducing mode, the brake oil held between each holding solenoid valve 25c to 25f and each wheel cylinder 26a to 26d is stored in the reservoir 25k, 25l through the hydraulic piping L14, L24 and the hydraulic piping L15, L25, and thus the wheel cylinder pressure acting on each wheel cylinder 26a to 26d can be reduced. Thus, the brake actuator 25 can perform an anti-lock brake control of preventing any one of the front or rear wheels (not shown) from being locked and skidding on the road surface.

When the brake actuator 25 is in the pressure-increasing mode, the pressurizing pressure can be exerted on the brake oil by the pressurizing means. For instance, the master cut solenoid valves 25a, 25b can be opening-controlled based on the command current value from the control device 29 so that the opening becomes smaller than that in time of fully-open, where when the pressurizing pump 25m, 25n are drive-controlled based on the drive command value from the control device 29, the brake oil is introduced from the upstream side of each master cut solenoid valve 25a, 25b, that is, the hydraulic piping L10, L20 to each reservoir 25k, 25l. The brake oil introduced into each reservoir 25k, 25l is pressurized by the pressurizing pump 25m, 25n, and filled in each wheel cylinder 26a to 26d through the hydraulic piping L11, L21, each holding solenoid valve 25c to 25f, and the hydraulic piping L12, L22. Each master cut solenoid valve 25a, 25b pressure-adjusts the differential pressure between the brake oil on the downstream side of each master cut solenoid valve 25a, 25b, that is, the wheel cylinder pressure acting on each wheel cylinder 26a to 26d, and the brake oil on the upstream side of each master cut solenoid valve 25a, 25b, that is, the master cylinder pressure generated by the master cylinder 22 as the pressurizing pressure, and thus the wheel cylinder pressure becomes the total pressure of the master cylinder pressure and the pressurizing pressure. In other words, the total pressure of the manipulation pressure, the assisting pressure, and the pressurizing pressure acts on each wheel cylinder 26a to 26d as the wheel cylinder pressure, so that the manipulation pressure, the assisting pressure, and the pressurizing pressure are applied on the wheels and the pressure braking-force is generated.

The pressurizing means can pressurize the brake oil by the control device 29 even if the driver does not manipulate the brake pedal 21, that is, irrespective of the manipulation of the brake pedal 21 by the driver. In this case, the wheel cylinder pressure acting on each wheel cylinder 26a to 26d can be adjusted by controlling the brake actuator 25 by the brake control device 29 so as to be in the holding mode and the pressure-reducing mode. Therefore, the brake actuator 25 can carry out the traction control of suppressing skidding on the road surface when any one of the front or rear wheels (not shown) is transmitting the driving force to the road surface, a vehicle stability control (VSC) of suppressing any one of the front or rear wheels (not shown) from side-skidding while the hybrid vehicle (not shown) is turning, and the like.

Each wheel cylinder 26a to 26d, each brake pad 27a to 27d, and each brake rotor 28a to 28d generate the pressure braking-force when the wheel cylinder pressure of the brake oil filled in each wheel cylinder 26a to 26d acts. The hybrid vehicle (not shown) has the wheel cylinder 26a, the brake pad 27a, and the brake rotor 28a arranged on the right front wheel, the wheel cylinder 26b, the brake pad 27b, and the brake rotor 28b arranged on the left rear wheel, the wheel cylinder 26c, the brake pad 27c, and the brake rotor 28c arranged on the right rear wheel, and the wheel cylinder 26d, the brake pad 27d, and the brake rotor 28d arranged on the left front wheel. In other words, the piping of the hydraulic brake device 2 is arranged in cross piping with respect to each wheel. Each wheel cylinder 26a to 26d makes each brake rotor 28a to 28d facing each brake pad 27a to 27d that integrally rotates with each wheel contact on each brake pad 27a to 27d when the wheel cylinder pressure acts, and generates the pressure braking-force by the frictional force generated between each brake pad 27a to 27d and each brake rotor 28a to 28d. Each brake pad 27a, 27b and the brake rotors 28a, 28b arranged on the left and right front wheels are set so as to generate a frictional force greater than the frictional force generated between each brake pad 27c, 27d and the brake rotor 28c, 28d arranged on the left and right rear wheels when the same braking pressure acts on each wheel cylinder 26a to 26d.

The brake control device 29 generates the braking force based on the braking request of the driver by controlling the braking apparatus 1. The brake control device 29 particularly controls the hydraulic brake device 2. As shown in FIG. 1, the brake control device 29 receives various input signals from the braking apparatus 1 and the sensors arranged in the hybrid vehicle (not shown). The input signal includes, for example, the execution regenerative braking-force from the regenerative braking device 3, the stroke amount detected by the stroke sensor 21a, the negative pressure detected by the negative pressure sensor 23a, the master cylinder pressure detected by the master cylinder pressure sensor 24, and the like in the embodiment.

The brake control device 29 outputs various output signals based on the input signals and various maps stored in advance in the storage unit 29c. The output signal includes, for example, target regenerative braking-force for causing the regenerative braking device 3 to perform regenerative braking, signals for performing the opening control of each master cut solenoid valve 25a, 25b, the ON/OFF control of each holding solenoid valve 25c to 25f, the ON/OFF control of each depressurizing solenoid valve 25g to 25j, the drive control of each pressurizing pump 25m, 25n, and the like in the embodiment.

The brake control device 29 is configured by an input/output unit (I/O) 29a for input and output of the input signal and the output signal, a processing unit 29b, and a storage unit 29c. The processing unit 29b is configured by a memory and a CPU (Central Processing Unit). The processing unit 29b includes at least a request braking-force calculating unit 29d, a target regenerative braking-force calculating unit 29e, a pressurizing braking-force calculating unit 29f, a valve opening control unit 29g, and a pump drive control unit 29h. The processing unit 29b may load the program based on the method for controlling the braking apparatus 1 and the like in the memory and execute the same to realize the method for controlling the braking apparatus 1, in particular, the method for controlling the braking apparatus 1.

The storage unit 29c is a storage means in which various maps such as PMC-Fpd-PV map, PMC-Fpd-dST(+) map, PMC-Fpd-dST(−) map, BF*-Fpd map, Pp-I map, and the like are stored in advance. The storage unit 29c can be configured by a non-volatile memory such as flash memory, memory enabling only readout such as ROM (Read Only Memory), memory enabling read and write such as RAM (Random Access Memory), or a combination thereof.

As shown in FIG. 3, the PMC-Fpd-PV map is based on the master cylinder pressure PMC, the pedal force Fpd, and the negative pressure PV, and shows a correspondence of the master cylinder pressure PMC, the pedal force Fpd, and the negative pressure PV. The PMC-Fpd-PV map is set such that the pedal force Fpd is calculated to increase with increase in the master cylinder pressure PMC. In the PMC-Fpd-PV map, with the correspondence of the master cylinder pressure PMC and the pedal force Fpd at the reference negative pressure PVb or the reference value, or in the embodiment, at the negative pressure (negative pressure detected by the negative pressure sensor 23 in the operation of the internal combustion engine) supplied to the brake booster 23 that is the assisting means during the operation of the internal combustion engine (not shown) as a reference, a plurality of correspondences of the master cylinder pressure PMC and the pedal force Fpd when the braking request is made by the driver when the negative pressure PV is lower than the reference negative pressure PV, that is, when the operation of the internal combustion engine is stopped are set. Each correspondence is set such that the pedal force Fpd is calculated to increase at the same master cylinder pressure PMC, compared to the correspondence of the master cylinder pressure PMC and the pedal force Fpd at the reference negative pressure PVb, with the lowering of the negative pressure PV with respect to the reference negative pressure PVb. That is, if the negative pressure PV detected by the negative pressure sensor 23a is lower than the reference negative pressure PVb, the pedal force Fpd is calculated to increase with the lowering of the negative pressure PV with respect to the reference negative pressure PVb if the master cylinder pressure PMC detected by the master cylinder pressure sensor 24 is the same. In the PMC-Fpd-PV map, the correspondence of the master cylinder pressure PMC and the pedal force Fpd satisfies, and the pedal force Fpd increases at the portion where the pedal force Fpd is constant until the master cylinder pressure PMC reaches a predetermined value (X1 in the figure), that is, at the jumping portion (points A to D in the figure) with the lowering of the negative pressure PV with respect to the reference negative pressure PVb.

As shown in FIG. 4, the PMC-Fpd-dST(+) map is based on the master cylinder pressure PMC, the pedal force Fpd, and the manipulation speed dST, and shows a correspondence of the master cylinder pressure PMC, the pedal force Fpd, and the manipulation speed dST(+) when the driver is depressing the brake pedal 21, that is, on the depressing side of the brake pedal 21. The detected manipulation speed dST takes a positive value if on the depressing side of the brake pedal 21. The PMC-Fpd-dST(+) map is set such that the pedal force Fpd is calculated to increase with increase in the master cylinder pressure PMC. In the PMC-Fpd-dST(+) map, with the correspondence of the master cylinder pressure PMC and the peal force Fpd at the depressing side reference manipulation speed +dSTb, in the embodiment, when the driver slowly and statically depresses the brake pedal 21, that is, when the brake pedal 21 is not rapidly depressed as the reference, a plurality of correspondences of the master cylinder pressure PMC and the pedal force Fpd when the brake pedal 21 is rapidly depressed than at the depressing side reference manipulation speed +dSTb are set. Each correspondence is set such that the pedal force Fpd is calculated to increase at the same master cylinder pressure PMC, compared to the correspondence of the master cylinder pressure PMC and the pedal force Fpd at the depressing side reference manipulation speed +dSTb, with increase to the depressing side of the manipulation speed dST (increase to positive side of manipulation speed dST) with respect to the depressing side reference manipulation speed +dSTb. That is, if the manipulation speed dST detected by the stroke sensor 21a is greater than the depressing side reference manipulation speed +dSTb, the pedal force Fpd is calculated to increase with increase to the depressing side of the manipulation speed dST with respect to the depressing side reference manipulation speed +dSTb if the master cylinder pressure PMC detected by the master cylinder pressure sensor 24 is the same. This is because the response characteristics of the brake booster 23 change according to the manipulation speed dST of the brake pedal 21 by the driver. In the brake booster 23, the responsiveness delays, and the generation of the assisting force that assists the manipulation force delays when the brake pedal 21 is rapidly depressed by the driver (manipulation speed dST is large). That is, if the brake pedal 21 is rapidly depressed, the response characteristics of the brake booster 23 change and the braking force may become insufficient. The PMC-Fpd-dST(+) map is set such that the calculated pedal force Fpd becomes substantially the same when the master cylinder pressure PMC becomes greater than or equal to a predetermined value (X2 in the figure) since the change in the response characteristics of the brake booster 23 occur at the initial stage of rapid depressing. In the embodiment, the PMC-Fpd-dST(+) map is set for each correspondence set in the PMC-Fpd-PV map. That is, the PMC-Fpd-dST(+) map is set corresponding to each correspondence set in the PMC-Fpd-PV map. The correspondence of the master cylinder pressure PMC and the pedal force PV at the depressing side reference manipulation speed +dSTb of each PMC-Fpd-dST(+) map is preferably the same as each correspondence set in the PMC-Fpd-PV map.

As shown in FIG. 5, the PMC-Fpd-dST(−) map is based on the master cylinder pressure PMC, the pedal force Fpd, and the manipulation speed dST, and shows a correspondence of the master cylinder pressure PMC, the pedal force Fpd, and the manipulation speed dST(−) when returning the brake pedal 21 depressed by the driver, that is, on the returning side of the brake pedal 21. The detected manipulation speed dST takes a negative value if on the returning side of the brake pedal 21. The PMC-Fpd-dST(−) map is set such that the pedal force Fpd is calculated to increase with increase in the master cylinder pressure PMC. In the PMC-Fpd-dST(−) map, with the correspondence of the master cylinder pressure PMC and the pedal force Fpd at the returning side reference manipulation speed −dSTb, or in the present embodiment, when the driver rapidly and dynamically returns the brake pedal 21, that is, when the brake pedal 21 is rapidly returned as the reference, a plurality of correspondences of the master cylinder pressure PMC and the pedal force Fpd when the brake pedal 21 is returned more slowly than the returning side reference manipulation speed −dSTb are set. Each correspondence is set such that the pedal force Fpd is calculated to decrease at the same master cylinder pressure PMC, compared to the correspondence of the master cylinder pressure PMC and the pedal force Fpd at the returning side reference manipulation speed −dSTb, with decrease to the returning side of the manipulation speed dST (increase to positive side of manipulation speed dST) with respect to the returning side reference manipulation speed −dSTb. That is, if the manipulation speed dST detected by the stroke sensor 21a is greater than the returning side reference manipulation speed −dSTb, the step force Fpd is calculated to decrease with decrease to the returning side of the manipulation speed dST with respect to the returning side reference manipulation speed −dSTb if the master cylinder pressure PMC detected by the master cylinder pressure sensor 24 is the same. This is because the response characteristics of the brake booster 23 change according to the manipulation speed dST of the brake pedal 21 by the driver. In the brake booster 23, the responsiveness delays thereby generating hysteresis, and the decrease in the assisting force that assists the manipulation force delays when the brake pedal 21 is slowly returned by the driver. That is, if the brake pedal 21 is slowly returned, the response characteristics of the brake booster 23 change and the braking force is overly generated. The PMC-Fpd-dST(−) map is set such that the calculated pedal force Fpd becomes substantially the same when the master cylinder pressure PMC becomes greater than or equal to a predetermined value (X3 in FIG. 3) since the change in response characteristics of the brake booster 23 occur at the initial stage of slow returning. In the embodiment, the PMC-Fpd-dST(−) map is set for each correspondence set in the PMC-Fpd-PV map. That is, the PMC-Fpd-dST(−) map is set corresponding to each correspondence set in the PMC-Fpd-PV map. The correspondence of the master cylinder pressure PMC and the pedal force Fpd at the returning side reference manipulation speed −dSTb of each PMC-Fpd-dST(−) map is preferably the same as each correspondence set in the PMC-Fpd-PV map.

As shown in FIG. 6, the BG*-Fpd map is based on the request braking-force BF* and the pedal force Fpd, and shows a correspondence of the request braking-force BF* and the pedal force Fpd. The BF*-Fpd map is set such that the request braking-force BF* is calculated to increase with increase in the calculated pedal force Fpd.

As shown in FIG. 7, the Pp-I map is based on the pressurizing pressure and the command current value, and shows the pressure-current correspondence, which is the correspondence of the pressurizing pressure and the command current value. The Pp-I map is set such that the command current value is calculated to increase with increase in the pressurizing pressure. Furthermore, the Pp-I map is also set such that the pressurizing pressure at which the command current value becomes greater than or equal to the offset current value is generated.

The request braking-force calculating unit 29d of the processing unit 29b is a request braking-force calculating means, and calculates the request braking-force based on the braking request of the driver. The request braking-force calculating unit 29d basically calculates the pedal force Fpd based on the master cylinder pressure PMC detected by the master cylinder pressure sensor 24, the negative pressure PV detected by the negative pressure sensor 23a, and the PMC-Fpd-PV map, and calculates the request braking-force BF* based on the calculated pedal force Fpd and the BF*-Fpd map. If the detected negative pressure PV is lower than the reference negative pressure PVb, the pedal force Fpd is calculated to increase with lowering of the negative pressure PV with respect to the reference negative pressure PVb, and thus the request braking-force BF* calculated based on the calculated pedal force Fpd and the BF*-Fpd map becomes greater than the request braking-force BF* calculated at the reference negative pressure PVb. In other words, the request braking-force calculating unit 29d calculates the request braking-force when the detected assisting force is smaller than the reference value to be greater than the request braking-force when the detected assisting force is the reference value. Therefore, the request braking-force calculated when the detected assisting force is smaller than the reference value becomes greater than the request braking-force calculated when the detected assisting force is the reference value.

When the manipulation speed dST detected by the stroke sensor 21a is on the depressing side (positive side) of the brake pedal 21 and is greater than the depressing side reference manipulation speed +dSTb, the pedal force Fpd is calculated based on the master cylinder pressure PMC detected by the master cylinder pressure sensor 24, the detected manipulation speed dST, and the PMC-Fpd-dST(+) map corresponding to the correspondence of the master cylinder pressure PMC and the pedal force Fpd at the detected negative pressure PV, and the request braking-force BF* is calculated based on the calculated pedal force Fpd and the BF*-Fpd map. If the detected manipulation speed dST is greater than the depressing side reference manipulation speed +dSTb, the pedal force Fpd is calculated to increase with increase to the depressing side of the manipulation speed dST with respect to the depressing side reference manipulation speed +dSTb, and thus the request braking-force BF* calculated based on the calculated pedal force Fpd and the BF*-Fpd map becomes greater than the request braking-force BF* calculated at the depressing side reference manipulation speed +dSTb.

When the manipulation speed dST detected by the stroke sensor 21a is on the returning side (negative side) of the brake pedal 21 and is greater than the returning side reference manipulation speed −dSTb, the pedal force Fpd is calculated based on the master cylinder pressure PMC detected by the master cylinder pressure sensor 24, the detected manipulation speed dST, and the PMC-Fpd-dST(−) map corresponding to the correspondence of the master cylinder pressure PMC and the pedal force Fpd at the detected negative pressure PV, and the request braking-force BF* is calculated based on the calculated pedal force Fpd and the BF*-Fpd map. If the detected manipulation speed dST is greater than the returning side reference manipulation speed −dSTb, the pedal force Fpd is calculated to decrease with decrease to the returning side of the manipulation speed dST with respect to the returning side reference manipulation speed −dSTb, and thus the request braking-force BF* calculated based on the calculated pedal force Fpd and the BF*-Fpd map becomes smaller than the request braking-force BF* calculated at the returning side reference manipulation speed −dSTb.

The target regenerative braking-force calculating unit 29e of the processing unit 29b is a regenerative braking-force calculating means, and calculates the target regenerative braking-force BFr* based on the request braking-force BF* calculated by the request braking-force calculating unit 29d, and the manipulation braking-force BFpmc calculated based on the master cylinder pressure PMC detected by the master cylinder pressure sensor 24.

The pressurizing braking-force calculating unit 29f of the processing unit 29b is a pressurizing braking-force calculating means, and calculates the pressurizing braking-force BFpp based on the request braking-force BF* calculated by the request braking-force calculating unit 29d, and the manipulation braking-force BFpmc calculated based on the master cylinder pressure PMC detected by the master cylinder pressure sensor 24, and the execution regenerative braking-force BTK actually generated by the regenerative braking-force generating system 4.

The valve opening control unit 29g of the processing unit 29b performs opening control of each master cut solenoid valve 25a, 25b. The valve opening control unit 29g calculates a command current value I based on the pressurizing pressure Pp calculated based on the pressurizing braking-force calculated by the pressurizing braking-force calculating unit 29f and the Pp-I map, and performs the opening control of each master cut solenoid valve 25a, 25b based on the calculated command current value I.

The pump drive control unit 29h of the processing unit 29b drive-controls the drive motor 25s to drive each pressurizing pump 25m, 25n.

The regenerative braking device 3 is a regenerative braking means, and generates a regenerative braking-force to perform regenerative braking. The regenerative braking device 3 generates the regenerative braking-force based on the target regenerative braking-force BFr* calculated by the target regenerative braking-force calculating unit 29e. That is, the regenerative braking device 3 generates the difference between the request braking-force BF* calculated by the request braking-force calculating unit 29d and the manipulation braking-force BFpmc calculated based on the master cylinder pressure PMC, that is, the pressure braking-force when the pressurizing pressure Pp is not exerted on the brake oil by the pressurizing means and the pressurizing braking-force is not generated. The regenerative braking device 3 is configured by a motor generator 31, an inverter 32, a battery 33, and a motor generator control device 34. It functions as a generator and also functions as a motor, and is, for example, a synchronous power generator motor. The motor generator 31 is coupled to an axle, and exerts a rotational force on the wheel attached to the axle through the axle when functioning as the motor, and generates the regenerative braking-force at the axle based on the rotational force of the wheel when functioning as the generator. The motor generator 31 is connected to the battery 33 by way of the inverter 32. To the motor generator 31 is supplied power from the battery 33, and the motor generator 31 can function as a motor by being rotatably driven, and can function as the generator by performing regenerative braking and storing the generated power in the battery 33. The motor generator 31 is connected to the motor generator control device 34. The motor generator control device 34 performs the drive control for making the motor generator 31 function as the motor or the regenerative brake control for making the motor generator 31 function as the generator through the inverter 32. The motor generator control device 34 is connected to the hybrid control device 4, and performs the switching control of the inverter 32 according to the drive control from the hybrid control device 4 or the instruction of the regenerative brake control based on the target regenerative braking-force BFr*. The hybrid control device 4 receives the number of rotations of the motor generator 31, the phase current value to the motor generator 31, and the like via the motor generator control device 34. The battery 33 is connected to a battery control device (not shown), and is managed by the battery control device. The battery control device calculates remaining capacity SOC, input/output limit, and the like based on the charging/discharging current, the battery temperature, and the like. The battery control device is connected to the hybrid control device 4, so that the remaining capacity SOC and the like are output to the hybrid control device 4.

The hybrid control device 4 operation-controls the hybrid vehicle (not shown) in a comprehensive manner. The hybrid control device 4 is connected to the brake control device 29, the motor generator control device 34, an engine control device for operation-controlling the internal combustion engine (not shown), the battery control device (not shown), a transmission control device for controlling the transmission that transmits the driving force of the internal combustion engine to the wheel, and the like. The hybrid control device 4 receives ON/OFF of the ignition switch (not shown), the shift position of the shift lever (not shown), the acceleration opening of the acceleration pedal (not shown), the vehicle speed of the hybrid vehicle (not shown), and the like from sensors arranged in the hybrid vehicle (not shown).

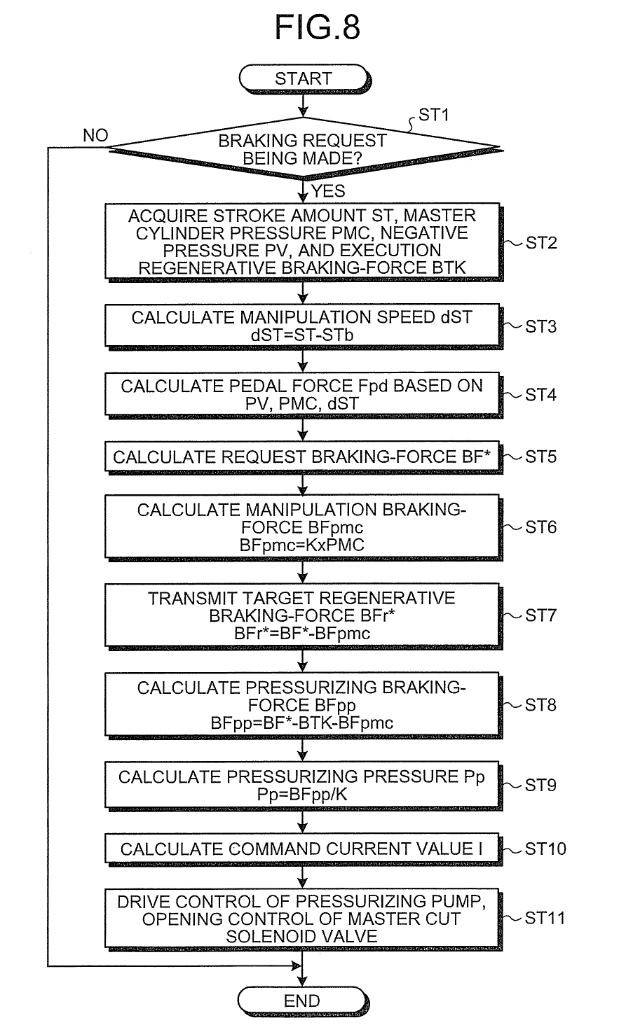

The method for controlling the braking apparatus 1 according to the embodiment, in particular, the method for controlling the braking force generated by the braking apparatus 1 will now be described. FIG. 8 is a view showing a flow of the method for controlling the braking apparatus according to the embodiment. The method for controlling the braking apparatus 1 is performed every control period of the braking apparatus 1 such as every few msec.

First, as shown in the figure, the processing unit 29b of the brake control device 29 judges whether or not the braking request is being made (step ST1). Here, the processing unit 29b judges whether or not the braking request is made by the driver by detecting whether or not the brake pedal 21 is depressed by the driver by means of a pedal force detection sensor (not shown) for detecting the depression of the brake pedal 21. When judged that the braking request is not being made, that is, the braking request by the driver is not made (NO in step ST1), the processing unit 29b terminates the current control period, and transitions to the next control period.

When judged that the braking request is made by the driver (YES in step ST1), the processing unit 29b acquires the stroke amount ST, the master cylinder pressure PMC, the negative pressure PV, and the execution regenerative braking-force BTK (step ST2). Here, the processing unit 29b acquires the stroke amount ST detected by the stroke sensor 21a and output to the brake control device 29, acquires the master cylinder pressure PMC or the manipulation pressure detected by the master cylinder pressure sensor 24 and output to the brake control device 29, acquires the negative pressure PV detected by the negative pressure sensor 23a and output to the brake control device 29, and acquires the execution regenerative braking-force BTK calculated based on the number of rotations of the motor generator 31 and the remaining capacity SOC of the battery 33 by the hybrid control device 4. The execution regenerative braking-force BTK is calculated before transitioning to the current control period by the hybrid control device 4.

The request braking-force calculating unit 29d calculates the manipulation speed dST (step ST3). The request braking-force calculating unit 29d calculates the current manipulation speed dST of the brake pedal 21 by subtracting the stroke amount STb acquired in the previous control period from the acquired stroke amount ST (dST=ST−STb). Therefore, in the embodiment, the stroke sensor 21a detects the manipulation speed dST by calculating the manipulation speed dST by means of the request braking-force calculating unit 29d. If the calculated manipulation speed dST is positive, the brake pedal 21 is in a depressed state, and if negative, the depressed brake pedal is being returned. That is, the calculated manipulation speed dST is the depressing side of the brake pedal 21 when on the positive side, and the returning side of the brake pedal 21 when on the negative side.

The request braking-force calculating unit 29d then calculates the pedal force Fpd (step ST4). The request braking-force calculating unit 29d first calculates the pedal force Fpd based on the acquired master cylinder pressure PMC, the acquired negative pressure PV, and the PMC-Fpd-PV map shown in FIG. 3 in the embodiment. If the calculated manipulation speed dST is on the depressing side of the brake pedal 21, that is, the calculated manipulation speed dST is positive, and is faster than the depressing side reference manipulation speed +dSTb, the pedal force Fpd is calculated based on the acquired master cylinder pressure PMC, the calculated manipulation speed dST, and the PMC-Fpd-dST(+) map shown in FIG. 4. If the calculated manipulation speed dST is on the returning side of the brake pedal 21, that is, the calculated manipulation speed dST is negative, and is slower than the returning side reference manipulation speed −dSTb, the pedal force Fpd is calculated based on the acquired master cylinder pressure PMC, the calculated manipulation speed dST, and the PMC-Fpd-dST(−) map shown in FIG. 5. That is, if the calculated manipulation speed dST is on the depressing side of the brake pedal 21 and the brake pedal 21 is depressed faster than the depressing side reference manipulation speed +dSTb, and if the calculated manipulation speed dST is on the returning side of the brake pedal 21 and the brake pedal 21 is returned faster than the returning side reference manipulation speed −dSTb, the calculated pedal force Fpd becomes the pedal force Fpd calculated using the PMC-Fpd-PV map shown in FIG. 3.

As shown in FIG. 8, the request braking-force calculating unit 29d then calculates the request braking-force BF* (step ST5). The request braking-force calculating unit 29d calculates the request braking-force BF* corresponding to the braking request of the driver based on the calculated pedal force Fpd and the BF*-Fpd map shown in FIG. 6.

As shown in FIG. 8, the processing unit 29b calculates the manipulation braking-force BFpmc (step ST6). In the embodiment, the processing unit 29b multiplies the conversion coefficient K to the acquired master cylinder pressure PMC to calculate the manipulation braking-force BFpmc (BFpmc=K×PMC) generated when the master cylinder 22 exerts the master cylinder pressure on the brake oil according to the manipulation force generated by the manipulation of the brake pedal 21 by the driver. The conversion coefficient K is uniquely determined according to the friction coefficient of each brake pad 27a to 27d, the diameter of each brake rotor 28a to 28d, the diameter of the tire attached to each wheel, the cylinder cross-sectional area of each wheel cylinder 26a to 26d, and the like.

The target regenerative braking-force calculating unit 29e then transmits the target regenerative braking-force BFr* to the hybrid control device 4 (step ST7). First, the target regenerative braking-force calculating unit 29e subtracts the calculated manipulation braking-force BFpmc from the calculated request braking-force BF* to calculate the target regenerative braking-force BFr* that is the braking-force desirably generated by the regenerative braking device 3 (BFr*=BF*-BFpmc). The target regenerative braking-force calculating unit 29e transmits the calculated target regenerative braking-force BFr* to the hybrid control device 4, and the hybrid control device 4 transmits the same to the motor generator control device 34. The motor generator control device 34 performs the switching control of the inverter 32 to perform the regenerative brake control based on the target regenerative braking-force on the motor generator 31 and generate the regenerative braking-force. The regenerative braking device 3 performs the regenerative brake control based on the target regenerative braking-force BFr*, but may not necessarily always generate the calculated target regenerative braking-force BFr* since the regenerative braking-force that can be generated is determined depending on the number of rotation of the motor generator 31 and the remaining capacity SOC of the battery 33.

As described above, in the embodiment, the request braking-force BF* calculated by the request braking-force calculating unit 29d becomes greater than the request braking-force BF* calculated at the reference negative pressure PV with lowering of the negative pressure PV with respect to the reference negative pressure PVb when the operation of the internal combustion engine (not shown) is stopped and the braking request is made by the driver. That is, the request braking-force BF* calculated when the detected negative pressure PV is lower than the reference negative pressure PVb is greater than the request braking-force BF* calculated when the detected negative pressure PV is the reference negative pressure PVb. Therefore, the target regenerative braking-force BFr* calculated using the calculated request braking-force BF* becomes greater than the target regenerative braking-force BFr* calculated using the request braking-force BF* calculated at the reference negative pressure PVb. The regenerative braking device 3 generates the difference between the calculated request braking-force BF* and the pressure braking-force as the regenerative braking-force, and thus generates the regenerative braking-force to be greater when the detected negative pressure PV is lower than the reference negative pressure PVb than that when the detected negative pressure PV is the reference negative pressure PVb (greater than or equal to the reference negative pressure PVb). The request braking-force BF* calculated by the request braking-force calculating unit 29d becomes greater than the request braking-force BF* calculated at the depressing side reference manipulation speed +dSTb with increase to the depressing side with respect to the depressing side reference manipulation speed +dST when the calculated manipulation speed dST is on the depressing side of the brake pedal 21. Therefore, the target regenerative braking-force BFr* calculated using the calculated request braking-force BF* becomes greater than the target regenerative braking-force BFr* calculated using the request braking-force BF* calculated at the depressing side reference manipulation speed +dSTb. Furthermore, the request braking-force BF* calculated by the request braking-force calculating unit 29d becomes smaller than the request braking-force BF* calculated at the returning side reference manipulation speed −dSTb with decrease to the returning side with respect to the returning side reference manipulation speed −dSTb when the calculated manipulation speed dST is on the returning side of the brake pedal 21. Therefore, the target regenerative braking-force BFr* calculated using the calculated request braking-force BF* becomes smaller than the target regenerative braking-force BFr* calculated using the request braking-force BF* calculated at the returning side reference manipulation speed −dSTb. In other words, the regenerative braking device 3 changes the regenerative braking-force to be generated according to the detected manipulation speed dST.

The pressurizing braking-force calculating unit 29f calculates the pressurizing braking-force BFpp (step ST8). The pressurizing braking-force calculating unit 29f subtracts the acquired execution regenerative braking-force BTK and the calculated manipulation braking-force BFpmc from the calculated request braking-force BF* to calculate the pressurizing braking-force BFpp by pressurization generated when the pressurizing pressure exerted on the brake oil by each master cut solenoid valve 25a, 25b and each pressurizing pump 25m, 25n is exerted (BFpp=BF*-BTK-BFpmc). The execution regenerative braking-force BTK is used instead of the target regenerative braking-force BFr* when calculating the pressurizing braking-force BFpp because the regenerative braking device 3 is not always able to generate the calculated target regenerative braking-force BFr*, and thus the execution regenerative braking-force BTK that is the actual regenerative braking-force acquired in advance is used.

The pressurizing braking-force calculating unit 29f does not calculate the pressurizing braking-force BFpp, that is, the pressurizing braking-force BFpp=0 if the calculated request braking-force BF* does not exceed the braking-force, which is the sum of the calculated manipulation braking-force BFpmc and the acquired execution regenerative braking-force BTK, whereby each master cut solenoid valve 25a, 25b and each pressurizing pump 25m, 25n that are the pressurizing means do not operate. That is, in the braking apparatus 1, the regenerative braking device 3 is operated in preference to each master cut solenoid valve 25a, 25b and each pressurizing pump 25m, 25n when operating each master cut solenoid valve 25a, 25b and each pressurizing pump 25m, 25n, and the regenerative braking device 3. Therefore, in the embodiment, if the negative pressure PV detected when the operation of the internal combustion engine (not shown) is stopped and the braking request is made by the driver is lower than the reference negative pressure PVb, the amount of increase with respect to the request braking-force BF* calculated at the reference negative pressure PVb of the calculated request braking-force BF* is compensated by the pressurizing braking-force BFpp for the portion that cannot be compensated even by increasing the regenerative braking-force. When the calculated manipulation speed dSTb is on the depressing side of the brake pedal 21 and is greater on the depressing side (positive side) than the depressing side reference manipulation speed +dSTb, the amount of increase with respect to the request braking-force BF* calculated at the depressing side reference manipulation speed +dSTb of the calculated request braking-force BF* is compensated by the pressurizing braking-force BFpp for the portion that cannot be compensated even by increasing the regenerative braking-force. When the calculated manipulation speed dSTb is on the returning side of the brake pedal 21 and is greater on the returning side (negative side) than the depressing side reference manipulation speed +dSTb, the calculated request braking-force BF* decreases with respect to the request braking-force BF* calculated at the depressing side reference manipulation speed +dSTb, but the difference between the target regenerative braking-force BFr* and the execution regenerative braking-force BTK cannot be compensated by the regenerative braking-force if the execution regenerative braking-force BTK is small with respect to the target regenerative braking-force BFr*, and thus it is compensated by the pressurizing braking-force BFpp.

The processing unit 29b then calculates the pressurizing pressure Pp (step ST9). Here, in the embodiment, the pressurizing braking-force calculating unit 29f divides the calculated pressurizing braking-force BFpp by the conversion coefficient K to calculate the pressurizing pressure Pp (Pp=BFpp/K) exerted on the brake oil by each master cut solenoid valve 25a, 25b and each pressurizing pump 25m, 25n.

The processing unit 29b then calculates the command current value I, and calculates the drive command value d (step ST10). The processing unit 29b calculates the command current value I for performing the opening control of each master cut solenoid valve 25a, 25b based on the calculated pressurizing pressure Pp and the Pp-I map shown in FIG. 7. The processing unit 29b also calculates the drive command value I for performing the drive control of each pressurizing pump 25m, 25n based on the pressurizing braking-force BFpp calculated by the pressurizing braking-force calculating unit 29f.

The valve opening control unit 29g of the processing unit 29b performs the opening control of each master cut solenoid valve 25a, 25b based on the output command current value I (step ST11). In this case, each pressurizing pump 25m, 25n is constantly drive-controlled at the determined number of rotations by the pump drive control unit 29h of the processing unit 29b to maintain a constant discharge amount. The processing unit each pressurizing pump 25m, 25n is drive-controlled to maintain a constant discharge amount, and each master cut solenoid valve 25a, 25b is opening-controlled, whereby the wheel cylinder pressure, which is the downstream side of each master cut solenoid valve 25a, 25b becomes the sum of the master cylinder pressure PMC, which is the upstream side of each master cut solenoid valve 25a, 25b and the pressurizing pressure Pp that is the differential pressure. In other words, the wheel cylinder pressure, which is the pressure of the brake oil filled in each wheel cylinder 26a to 26d acting on each wheel cylinder 26a to 26d becomes the total pressure of the master cylinder pressure PMC and the pressurizing pressure Pp. Therefore, the pressure braking-force generated by the wheel cylinder pressure acting on each wheel cylinder 26a to 26d becomes the total of the manipulation braking-force based on the manipulation pressure and the assisting pressure, and the pressurizing braking-force based on the pressurizing pressure Pp.

As described above, the braking apparatus 1 attempts to generate the regenerative braking-force greater than the regenerative braking-force to be generated by the regenerative braking device 3 when the detected negative pressure PV is the reference negative pressure PVb when the detected negative pressure PV is lower than the reference negative pressure PV such as when the operation of the internal combustion engine (not shown) is stopped and the braking request is made by the driver. Therefore, the braking apparatus 1 increases the regenerative braking-force even if the negative pressure PV lowers with respect to the reference negative pressure PVb, the master cylinder pressure PMC lowers, and the pressure braking-force lowers, and compensates with the regenerative braking-force with the operation of the internal combustion engine stopped. Thus, the lack of braking force that occurs in a state the assisting force for assisting the manipulation force is lowered, that is, when the negative pressure PV generated by the internal combustion engine is lowered can be compensated by the regenerative braking-force, whereby the difference between the braking force generated by the braking apparatus 1 at the reference negative pressure PVb and the braking force generated by the braking apparatus 1 at the detected negative pressure PV becomes small. That is, even in the state the operation of the internal combustion engine is stopped, for example, the lack of braking force is suppressed, the uncomfortable feeling felt by the driver in manipulating the brake is suppressed, and furthermore the fuel consumption can be enhanced.

When the calculated manipulation speed dST is the depressing side of the brake pedal 21, the braking apparatus 1 attempts to generate the regenerative braking-force greater than the regenerative braking-force to be generated by the regenerative braking device 3 at the depressing side reference manipulation speed +dSTb with increase to the depressing side with respect to the depressing side reference manipulation speed +dSTb. When the calculated manipulation speed dST is the returning side of the brake pedal 21, the braking apparatus 1 attempts to generate the regenerative braking-force smaller than the regenerative braking-force to be generated by the regenerative braking device 3 at the returning side reference manipulation speed −dSTb with decrease to the returning side with respect to the depressing side reference manipulation speed −dSTb. Therefore, the braking apparatus 1 causes the regenerative braking device 3 to generate the regenerative braking-force following the change in the assisting force to the manipulation force by the brake booster 23 according to the manipulation speed dST of the brake pedal 21 by the driver. Thus, the difference between the braking force generated by the braking apparatus 1 at the depressing side reference manipulation speed +dSTb or the braking force generated by the braking apparatus 1 at the returning side reference manipulation speed −dSTb, and the braking force generated by the braking apparatus 1 at the detected manipulation speed dST can be reduced. That is, lack of braking force or excess braking force is suppressed, the uncomfortable feeling felt by the user in manipulating the brake is further suppressed, and fuel consumption can be enhanced.

When operating each master cut solenoid valve 25a, 25b and each pressurizing pump 25m, 25n, as well as the regenerative braking device 3, the braking apparatus 1 in preference operates the regenerative braking device 3 such that the difference between either the braking force generated by the braking apparatus 1 at the depressing side reference manipulation speed +dSTb or the braking force generated by the braking apparatus 1 at the returning side reference manipulation speed −dSTb, and the braking force generated by the braking apparatus 1 at the detected manipulation speed dST becomes small, whereby when the braking force lacks, the regenerative braking device 3 that generates energy is operated in preference to each master cut solenoid valve 25a, 25b and each pressurizing pump 25m, 25n that consumes energy generated by the vehicle in which the braking apparatus 1 is mounted, to thereby compensate for the lack of braking force. Therefore, the fuel consumption can be further enhanced.

In the above-described embodiment, the PMC-Fpd-dST(+) map and the PMC-Fpd-dST(−) map are respectively set in accordance with each correspondence set in the PMC-Fpd-PV map, but the present invention is not limited thereto. For instance, a three-dimensional map in which the correspondence of the master cylinder pressure PMC, the pedal force Fpd, the negative pressure PV, and the manipulation speed dST are set may be stored in the storage unit 29c in advance, and the pedal force Fpd may be calculated based on the acquired master cylinder pressure PMC, the acquired negative pressure PV, the calculated manipulation speed dST, and the three-dimensional map. Furthermore, the pedal force Fpd calculated based on the acquired master cylinder pressure PMC, the acquired negative pressure PV, and the PMC-Fpd-PV map may be corrected by a correction coefficient based on the calculated manipulation speed dST. In this case, the correction coefficient based on the manipulation speed dST corresponds to the correspondence of the master cylinder pressure PMC, the pedal force Fpd, and the manipulation speed dST in the PMC-Fpd-dST(+) map and the PMC-Fpd-dST(−) map.

### INDUSTRIAL APPLICABILITY

As described above, the braking apparatus and the method for controlling the braking apparatus according to the present invention are useful in the braking apparatus for generating the regenerative braking-force by means of the regenerative braking means and the method for controlling the braking apparatus, and in particular suited for suppressing the uncomfortable feeling felt by the driver in manipulating the brake, and for enhancing the fuel consumption.

1. A braking apparatus comprising:
a brake pedal manipulated by a driver;
a pressure braking-force generating unit that generates a pressure braking-force by applying a manipulation pressure corresponding to a manipulation force of the brake pedal and an assisting pressure corresponding to an assisting force that assists the manipulation force on a wheel;
a regenerative braking unit that generates a regenerative braking-force at an axle to which the wheel is attached based on a rotational force of the wheel;
an assisting force detection unit that detects the assisting force; and
a request braking-force calculating unit that calculates a request braking-force according to a pedal force of the driver on the brake pedal, wherein
the request braking-force calculating unit calculates the request braking-force to be greater than that when the assisting force is a reference value, when the detected assisting force is smaller than the reference value; and
the regenerative braking unit generates a difference between the calculated request braking-force and the pressure braking-force.

2. The braking apparatus according to claim 1, wherein
the assisting force is based on a negative pressure generated by an internal combustion engine, and
the assisting force detection unit is a negative pressure sensor that detects the negative pressure.

3. The braking apparatus according to claim 2, wherein a when the detected negative pressure is lower than the reference value, a braking request is made by the driver while the operation of the internal combustion engine is stopped.

4. The braking apparatus according to claim 1, further comprising:
a manipulation speed detection unit that detects a manipulation speed of the brake pedal, wherein
the regenerative braking unit changes the regenerative braking-force to be generated according to the detected manipulation speed.

5. The braking apparatus according to claim 4, wherein the regenerative braking unit increases the regenerative braking-force to be generated with increase in the detected manipulation speed to a depressing side of the brake pedal, when the detected manipulation speed is on a depressing side.

6. The braking apparatus according to claim 4, wherein the regenerative braking unit decreases the regenerative braking-force to be generated with decrease in the detected manipulation speed to a returning side of the brake pedal, when the detected manipulation speed is on a returning side.

7. The braking apparatus according to claim 1, further comprising:
a pressurizing unit that applies pressurizing pressure on the wheel regardless of the manipulation of the brake pedal by the driver, wherein
the regenerative braking unit is operated in preference to the pressurizing unit, when the detected assisting force is smaller than a reference value.

8. A method for controlling a braking apparatus based on a braking request of a driver, the method comprising:
detecting an assisting force that assists a manipulation force of a brake pedal;
judging whether the detected assisting force is smaller than a reference value;
calculating a request braking-force when the detected negative pressure is lower than a reference value to be greater than a request braking-force when the detected negative pressure is the reference value; and
generating, by a regenerative braking unit, a difference between the calculated request braking-force and a pressure braking-force generated by applying a manipulation pressure corresponding to the manipulation force and an assisting pressure corresponding to the assisting force on a wheel as a regenerative braking-force at an axle to which the wheel is attached based on a rotational force of the wheel.

9. The method for controlling a braking apparatus according to claim 8, wherein
the assisting force is based on a negative pressure generated by an internal combustion engine, and
the detecting an assisting force is performed by a negative pressure sensor that detects the negative pressure.

10. The method for controlling a braking apparatus according to claim 9, wherein a case that the detected negative pressure is lower than the reference value is a case that a braking request is made by the driver while the operation of the internal combustion engine is stopped.

11. The method for controlling a braking apparatus according to claim 8, further comprising:
detecting a manipulation speed of the brake pedal, wherein
the regenerative braking unit changes the regenerative braking-force to be generated according to the detected manipulation speed.

12. The method for controlling a braking apparatus according to claim 11, wherein the regenerative braking unit increases the regenerative braking-force to be generated with increase in the detected manipulation speed to a depressing side of the brake pedal, when the detected manipulation speed is on a depressing side.

13. The method for controlling a braking apparatus according to claim 11, wherein the regenerative braking unit decreases the regenerative braking-force to be generated with decrease in the detected manipulation speed to a returning side of the brake pedal, when the detected manipulation speed is on a returning side.

14. The method for controlling a braking apparatus according to claim 8, wherein
the braking apparatus further includes a pressurizing unit that applies pressurizing pressure on the wheel regardless of the manipulation of the brake pedal by the driver, and
the regenerative braking unit is operated in preference to the pressurizing unit, when the detected assisting force is smaller than a reference value.
